(19) United States
(12) Patent Application Publication
(10) Pub. No.: US 2007/0120807 A1
(43) Pub. Date: May 31, 2007

(54) Display system with high motion picture quality and luminance control thereof

(76) Inventors: Shwang-Shi Bai, Hsinhua (TW); Yu-Pei Huang, Hsinhua (TW); Shen-Yao Liang, Hsinhua (TW)

Correspondence Address: J.C. Patents, Inc., Suite 250, 4 Venture, Irvine, CA, 92618, US

(21) Appl. No.: 11/288,874

(22) Filed: Nov. 28, 2005

(51) Int. Cl. G09G 3/36

(52) U.S. Cl. 345/102

(57) ABSTRACT

Disclosed is a backlight control system for a display system with motion picture quality improvement and dynamic luminance control. In the backlight control system, a dynamic motion picture detector outputs an enable signal and a luminance control signal by judging whether the input video data are dynamic motion pictures or not. In response to the enable signal, a display quality improvement mechanism decides whether or not to trigger a display quality improvement. In case of the display quality improvement being triggered, a luminance control circuit and/or an inverter make a backlight module of the display system emit stronger lights for luminance compensation.

### BACKGROUND OF THE INVENTION

1. Field of Invention

The present invention relates to a backlight control system and an LCD (Liquid Crystal Display) system with the same, providing with motion picture quality improvement and dynamic luminance control for reducing afterimages.

2. Description of Related Art

Rapid development within the fields of information and communication has caused an increase in the demand for thin, lightweight and low cost display devices for viewing information. Industries that develop displays are responding to these needs by placing high emphasis on developing flat panel type displays.

Historically, the Cathode Ray Tube (CRT) has been widely used as a display device in applications such as televisions, computer monitors, and the like, because CRT screens can display various colors with high luminance. However, the CRT cannot adequately satisfy present demands for display applications that require reduced volume and weight, portability, and low power consumption, while having a large screen size and high resolution. Out of this need, the display industry has placed high emphasis on developing flat panel displays to replace the CRT. Over the years, flat panel displays have found wide use in monitors for computers, spacecraft and aircraft. Examples of flat panel display types currently used include the LCD, the electroluminescent display (ELD), the field emission display (FED) and the plasma display panel (PDP).

Characteristics required for an ideal flat panel display include lightweight, high luminance, high efficiency, high resolution, high speed response time, low driving voltage, low power consumption, low cost and natural color.

Development and application of thin film transistor (TFT)-LCD industries have been accelerated in accordance with the increase in the dimensions and increase in the resolution. A liquid crystal display apparatus allows either still or moving pictures to be displayed on a liquid crystal display panel by scanning the liquid crystal display panel.

The liquid crystal display apparatus, in order to provide brighter images, typically incorporates a backlight module on the rear surface of the liquid crystal panel thereof. The backlight module is driven by, for example, an inverter circuit, and emits light on the liquid crystal panel from the rear surface thereof. The backlight module at least includes several light sources, for example, two cold-cathode tubes, one for top area and the other for bottom area of the display module.

The liquid crystal display apparatus does not have a rapid response to high moving pictures. Therefore, there is a problem in that trailing of images (or afterimages) occurs when moving images are displayed, which degrades the picture quality.

Many efforts have been made to improve motion picture quality of the LCD display system. At present, there are ways for improving or reducing afterimages, for example, scanning backlight mechanism, black insertion (or black data insertion) mechanism and over-drive mechanism.

In scanning, a transition is occurred from a current frame scan to a next frame scan. First, the top cold-cathode tube is turned off while the bottom cold-cathode tube is turned on. Accordingly, a top area of the display module is rendered dark, while the bottom area of the display module remains bright so as to hold the image of the current frame within the bottom area. Then, a scanning for images of the next frame begins with the top area. When the scanning for the top area is completed, the top cold-cathode tube is turned on while the bottom cold-cathode tube is turned off. Accordingly, a top area of the display module is rendered bright, while the bottom area of the display module is dark so as to hold the image of the current frame within the area. Thereafter, the scanning for the bottom area of the next frame begins. When the bottom area is completely scanned, the bottom cold-cathode tube is turned on and the top cold-cathode tube remains on. Accordingly, the whole image of the next frame is displayed.

In the scanning backlight mechanism, the backlight is turned off for a short period in each area of the display module, further improving picture quality in addition to eliminating afterimages.

In black insertion mechanism, black data are inserted into the frame to be displayed. For example, black data are first inserted and overlapped top portion of the frame. Then, black data are inserted and overlapped the middle portion of the frame. Further, black data are inserted and overlapped the bottom portion of the frame.

Although the scanning backlight and the black insertion mechanisms have improved display quality by reducing afterimages, they still have drawbacks. For example, in scanning backlight mechanism, light sources for example, cold-cathode tubes, CCFLs (Cold Cathode Fluorescent Lamps), or LEDs (Light Emitting Diode) of the backlight module are turned on and off frequently, the life cycle of the backlight module is negatively affected and the brightness of the display image is lowered. In black insertion mechanism, because a portion of display area is rendered dark due to the insertion of black data, the charging of the liquid crystal cells may be insufficient, which reduces the display quality and the brightness of the display image is also lowered.

Therefore, a motion picture quality improvement with dynamic luminance compensation for the LCD display system is needed to overcome the drawbacks of the prior art.

### SUMMARY OF THE INVENTION

One of the aspects of the invention is to provide a display system with motion picture quality improvement and dynamic luminance compensation. By performing luminance compensation, the luminance difference caused by switching from triggered quality improvement into non-triggered quality improvement is ignorable.

Another aspect of the invention is to provide a motion picture detection, which dynamically detects whether the video data to be displayed is highly dynamic or not and shuts down the motion picture quality improvement mechanism when the video data is not highly dynamic.

For at least the above and other aspects, in one embodiment of the present invention, a backlight control system of a display system with a backlight module, which is capable for compensating luminance of the display system, is provided. The backlight control system includes a detector and an inverter. The detector outputs an enable signal and a luminance control signal by judging whether the input video data are dynamic motion picture or not. The inverter decides whether to trigger a display quality improvement based on the enable signal from the detector. When the inverter triggers the display quality improvement, a luminance control circuit inside the inverter makes the inverter to perform luminance compensation in response to the luminance control signal from the detector.

A further embodiment of the present invention provides a dynamic motion picture detector which includes a data latch latching the input video data and outputting a latched video data, a comparator comparing the input video data and the latched video data to output a comparison result and a judgment unit outputting the enable signal and the luminance control signal. When the comparison result indicates the input video data and the latched video data are not dynamic pictures, the judgment unit outputs an LOW enable signal; otherwise, the judgment unit outputs an HIGH enable signal.

Still another embodiment of the present invention provides a backlight control system of a display system for compensating luminance thereof; the display system further includes a backlight module. The backlight control system includes a timing controller and an inverter. The timing controller includes a dynamic motion picture detector and a display quality improvement circuit. The dynamic motion picture detector outputs an enable signal and a luminance control signal by judging whether the input video data are dynamic motion picture or not. In response to the enable signal the display quality improvement circuit decides whether or not to trigger a quality improvement. When the display quality improvement circuit triggers the display quality improvement, a luminance control circuit inside the inverter makes the inverter to perform luminance compensation in response to the luminance control signal.

In yet another embodiment of the present invention is to provide a display system for compensating luminance thereof, the display system further includes a backlight module. In the display system, a dynamic motion picture detector outputs an enable signal and a luminance control signal by judging whether the input video data are dynamic motion picture or not. Then, a display quality improvement mechanism decides whether to trigger a display quality improvement based on the enable signal. If the display quality improvement is triggered, a luminance control circuit makes the backlight module emit stronger lights for luminance compensation in response to the luminance control signal.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a display system according to a first embodiment of the present invention.

FIG. 2 is an exemplary block diagram of a dynamic motion picture detector in FIG. 1.

FIG. 3 is an exemplary block diagram of a luminance control circuit in FIG. 1.

FIG. 4 is a block diagram of a display system according to a second embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In the prior art, the afterimages reduction or the quality improvement mechanism is continuously triggered. If the display system shows still or slowly changing pictures, the needs for quality improvement are not necessary. On the other hand, in the embodiment, the quality improvement mechanism is dynamically triggered. Besides, if the quality improvement is triggered, luminance compensation is provided for enhancing luminance of the display system.

Further, if the afterimages reduction or the quality improvement is switched between triggered and non-triggered, the luminance from the light sources of the backlight module or the brightness of the displayed pictures is changed and may be aware by human beings. It is desirable that the luminance difference caused by the triggered and non-triggered switches of the quality improvement is to be eliminated and negligible so a viewer will not be aware of the switches, which causes discomfort feelings.

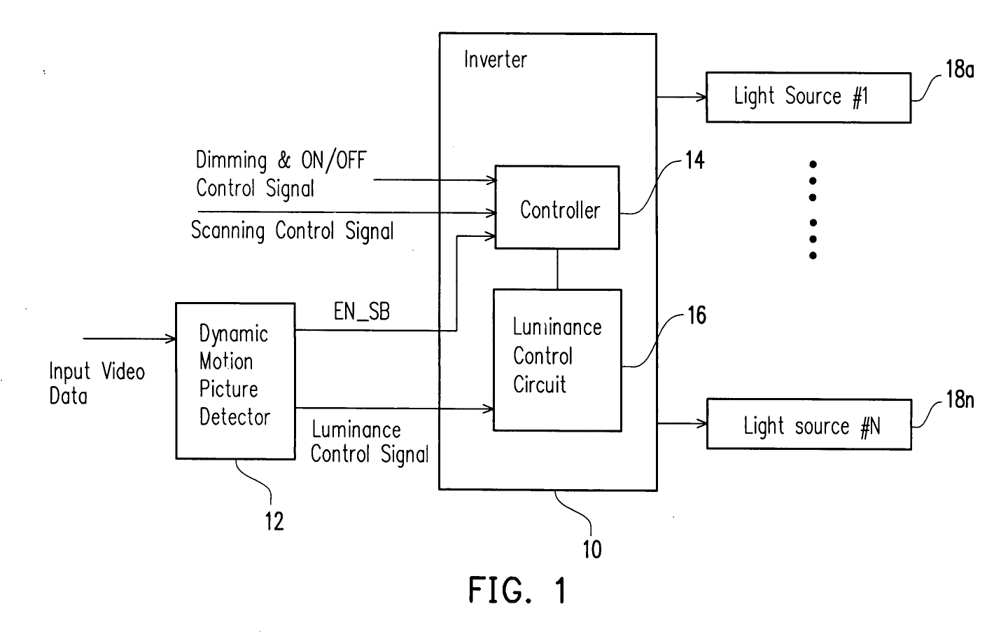

FIG. 1 is a block diagram of the display quality improvement and luminance compensation circuit according to a first embodiment of the present invention. The first embodiment is applicable in the scanning backlight mechanism.

Referring to FIG. 1, a dimming & ON/OFF signal indicates the brightness and on/off states of the light sources of the backlight module. The light sources are, for example but not limited to, CCFLs or LEDs. The scanning control signal makes the lights emitted from the ON light sources synchronously with the scanning of the frames on the display system. The input video data is from, for example, a graphic controller of PC system if the display system is used as an LCD display system/monitor of PC system.

An inverter 10 transforms DC (direct current) voltage into AC (alternating current) voltage to drive the light sources. The inverter 10 at least includes a controller 14 and a luminance control circuit 16. In response to the dimming & ON/OFF signal, the controller 14 controls the supply of the AC voltage to the light sources, which means the controller 14 controls the luminance and ON/OFF states of the light sources 18a˜18n. As known, if the AC voltage supply is higher, the light sources emit stronger lights.

A dynamic motion picture detector 12 detects and determines whether the input video data or motion pictures to be displayed are highly dynamic or just still slowly changing and whether to trigger the quality improvement mechanism or not. If the motion pictures are determined as still or slowly changing pictures, the dynamic motion picture detector 12 outputs an LOW enable signal EN_SB to the inverter 10 and the luminance control circuit 16 disables the quality improvement mechanism (the scanning backlight in this embodiment). If the motion pictures are determined as highly dynamic, the dynamic motion picture detector 12 outputs an HIGH enable signal EN_SB to the inverter 10 and the luminance control circuit 16 enables the quality improvement mechanism (the scanning backlight in this embodiment). The operation of the scanning backlight mechanism is not limited, as long as good improvements on afterimages are made.

In this embodiment, how the inverter 10 or the controller 14 controls the light sources 18a˜18n are not specially limited. For example, the inverter 10 or the controller 14 may provide respective or even different AC voltages to the light sources 18a˜18n to make the luminance and ON/OFF states of the light sources not necessary the same for a better performance.

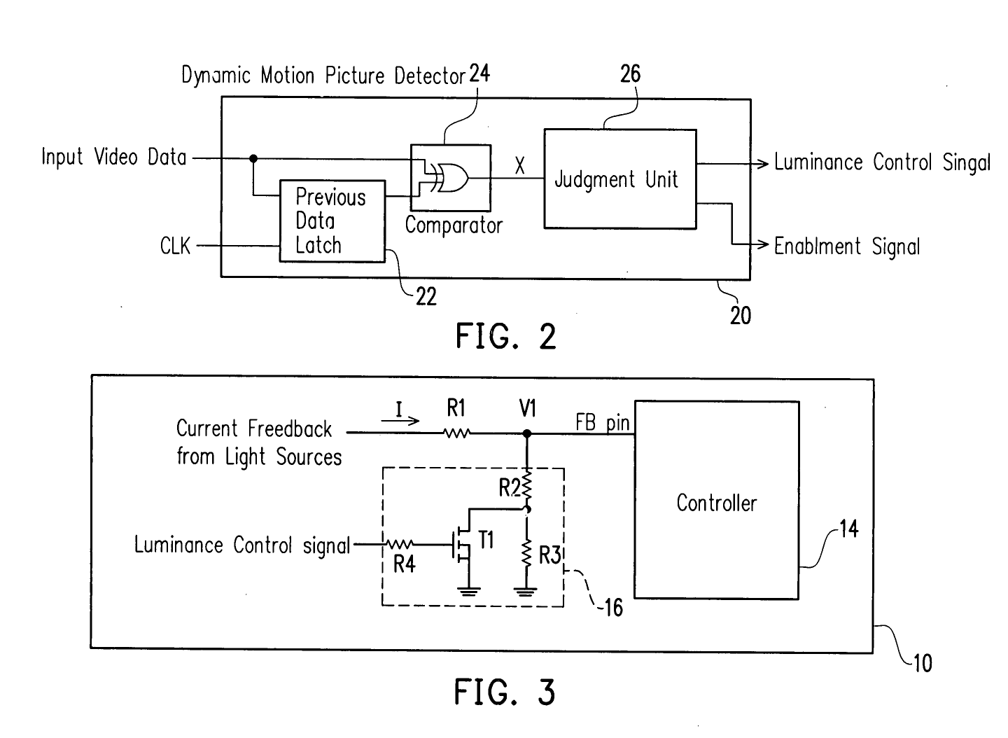

FIG. 2 is an exemplary block diagram of the dynamic motion picture detector. The dynamic motion picture detector may be used as the detector 12 of the first embodiment. As shown in FIG. 2, the dynamic motion picture detector 20 as least includes a previous data latch 22, a comparator 24 and a judgment unit 26.

The previous data latch 22 latches the video data under control of a clock signal CLK and provides a latched video data (or said, a video data of a previous frame) to the comparator 24.

The comparator 24 compares the gray scales of the video data samples of the current frame and the gray scales of the video data samples of the previous frame to output an indication signal X which indicates the two continuous frames are still/slowly changing or highly dynamic motion pictures. The comparator 24 at least includes an EXOR logic gate. When the signal X is logic 0, which means the sample between the two consecutive frames has the same gray scale, the two consecutive frames are determined as still/slowly changing frames. Similarly, when the signal X is logic 1, which means the sample between the two consecutive frames has the different gray scales, the two consecutive frames are determined as highly dynamic frames. Of course, for simplicity and efficiency, not all of the video data samples of the current frame and the previous frame are compared by the comparator 24. Please notes that the number of samples may be equal to the number of the signals X. For example, if 20 samples are used in comparison, then there will be 20 signals X.

The judgment unit 26 collects available signals X from the comparator 24 and outputs an enable signal and a luminance control signal to a next stage (for example, the luminance control circuit 16 in the inverter 10 of the first embodiment). When the enable signal is LOW, the luminance control signal is deactivated. An LOW enable signal indicates that the scanning backlight mechanism is disabled. An HIGH enable signal indicates that the scanning backlight mechanism is enabled and the AC voltages/currents supplied to the light sources are increased in response to the luminance control signal. The reason to increase the AC voltages/currents relies on that, because a triggered scanning backlight mechanism has slightly negative effects on luminance of the display system, increased AC voltages/currents will make the light sources emit stronger lights for luminance compensation of the display system.

FIG. 3 is an exemplary block diagram of the luminance control circuit used as the circuit 16 in the inverter 10 of the first embodiment. The luminance control signal is provided by, for example, the detector 12. The current feedback from the light sources are used by the controller 14 to control the AC voltages supplied to the light sources for more accurately controlling the luminance of the light sources. A resistor group of R1˜R3 transforms the feedback current I into a voltage V1. The controller 14 samples the voltage Vl to control the AC voltages supplied to the light sources. If V1 is lower than a predetermined voltage, the controller boosts the AC voltages supplied to the light sources. On the other hand, if V1 is higher than a predetermined voltage, the controller bucks the AC voltages supplied to the light sources. However, in the embodiment, V1 depends on not only the feedback current but also the luminance control signal. As shown, the luminance control circuit in the inverter at least includes three resistors R2˜R4 and an MOS transistor T1. The luminance control signal controls ON/OFF state of the MOS transistor T1 via the resistor R4. For simplicity, it is assumed that the resistance of the resistors R1˜R3 are all R. Further, it is assumed that the luminance control signal is defaulted as LOW, and if so, the quality improvement mechanism (the scanning backlight mechanism) is not triggered, the MOS transistor T1 is OFF and V1 is the same as the predetermined voltage set by the controller 14, which is I*(R2+R3)=21R. However, when the luminance control signal changes into HIGH, which means the quality improvement mechanism is triggered, the MOS transistor T1 is ON and V1 becomes as I*R2=IR, that is because an ON transistor has a resistance much smaller than R. In this case, since V1 is lower than the predetermined voltage, the controller 14 will increase the AC voltages supplied to the light sources and accordingly, the light sources emit stronger lights to compensate the luminance.

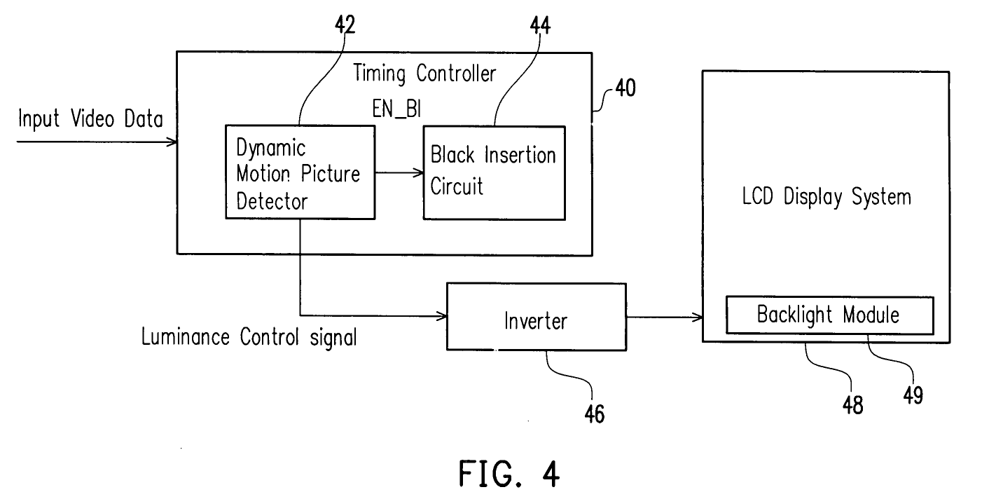

FIG. 4 is a block diagram according to a second embodiment of the present invention. The second embodiment is applicable in another quality improvement mechanism, for example, a black insertion mechanism. A timing controller 40 includes a dynamic motion picture detector 42 and a black insertion circuit 44. The detector 42 detects the input video data and outputs an enable signal EN_BI indicating whether to trigger the black insertion circuit 44 for quality improvement. In case of the signal EN_BI indicating the black insertion circuit 44 is enabled, the detector 42 outputs a luminance control signal to the inverter 46 and a luminance control circuit (not shown) inside the inverter 46 for luminance compensation.

When the black insertion circuit 44 is enabled, it will insert appropriate black data into the current frame for improving afterimages on the display system. How the black data is inserted is not limited here. After the luminance control circuit receives the luminance control signal from the detector 42, the luminance control circuit will inform the inverter 46 to make the backlight module 49 of the LCD display system 48 emit stronger lights to increase the luminance of the display system 48.

As discussed, in the prior art, when the scanning backlight or the black insertion mechanism is triggered for quality improvement, the luminance of the display system is negatively degraded. But, in the embodiments of the invention, even when the quality improvement mechanism (the scanning backlight, the black insertion mechanism or the like) is triggered, the inverter and the luminance control circuit will make the backlight module of the display system emit stronger lights for luminance compensation. Therefore, the drawback of the luminance degradation in the prior art is overcome.

Furthermore, in the prior art, when the state of the quality improvement mechanism is changed from non-triggered into triggered, the luminance degradation may be aware by human beings. But, in the embodiments of the invention, even when the state of the quality improvement mechanism is changed from non-triggered into triggered, due to luminance compensation, the luminance degradation is ignorable and not noticed by the viewers.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A backlight control system of a display system for compensating luminance thereof, the display system further including a backlight module, the backlight control system comprising:
a dynamic motion picture detector, receiving an input video data and outputting an enable signal and a luminance control signal by judging whether the input video data are dynamic motion pictures; and
an inverter, including a luminance control circuit the inverter deciding whether to trigger a display quality improvement based on the enable signal;
wherein when the inverter triggers the display quality improvement, the luminance control circuit makes the inverter perform luminance compensation in response to the luminance control signal.

2. The backlight control system of claim 1, wherein the inverter further comprises a controller controlling output voltages to the backlight module.

3. The backlight control system of claim 1, wherein the dynamic motion picture detector comprises:
a data latch, latching the input video data and outputting a latched video data;
a comparator, comparing the input video data and the latched video data to output a comparison result; and
a judgment unit, outputting the enable signal and the luminance control signal;
wherein when the comparison result indicates the input video data and the latched video data are not dynamic pictures, the enable signal is deactivated; otherwise, the enable signal is activated.

4. The backlight control system of claim 2, wherein the controller receives feedback currents from the backlight module via a first resistor; and
the luminance control circuit includes:
an MOS transistor, the luminance control signal controlling ON/OFF state of the MOS transistor;
a second resistor, coupled between the first resistor and the MOS transistor; and
a third resistor, coupled between the second resistor and a ground terminal;
wherein when the MOS transistor is turned off, the controller performs luminance compensation by controlling and varying output voltages to the backlight module in response to voltage division by the first and second resistors.

5. The backlight control system of claim 1, wherein the display quality improvement is a scanning backlight mechanism.

6. A backlight control system of a display system for compensating luminance thereof, the display system further including a backlight module, the backlight control system comprising:
a timing controller, including a dynamic motion picture detector and a display quality improvement circuit, the dynamic motion picture detector receiving an input video data and outputting an enable signal and a luminance control signal by judging whether the input video data are dynamic motion pictures, the display quality improvement circuit deciding whether to trigger a quality improvement based on the enable signal; and
an inverter, including a luminance control circuit;
wherein when the display quality improvement circuit triggers the display quality improvement, the luminance control circuit makes the inverter perform luminance compensation in response to the luminance control signal.

7. The backlight control system of claim 6, wherein the inverter further comprises a controller controls output voltages to the backlight module.

8. The backlight control system of claim 6, wherein the dynamic motion picture detector comprises:
a data latch, latching the input video data and outputting a latched video data;
a comparator, comparing the input video data and the latched video data to output a comparison result; and
judgment unit, outputting the enable signal and the luminance control signal;
wherein when the comparison result indicates the input video data and the latched video data are not dynamic pictures, the enable signal is deactivated; otherwise, the enable signal is activated.

9. The backlight control system of claim 7, wherein the controller receives feedback currents from the backlight module via a first resistor; and
the luminance control circuit includes:
an MOS transistor, the luminance control signal controlling ON/OFF state of the MOS transistor;
a second resistor, coupled between the first resistor and the MOS transistor; and
a third resistor, coupled between the second resistor and a ground terminal;
wherein when the MOS transistor is turned off, the controller performs luminance compensation by controlling and varying output voltages to the backlight module in response to voltage division by the first and second resistors.

10. The backlight control system of claim 6, wherein the display quality improvement circuit is a black insertion circuit.

11. A display system for compensating luminance thereof, the display system further including a backlight module, the display system comprising:
a dynamic motion picture detector, detecting an input video data and outputting an enable signal and a luminance control signal by judging whether the input video data are dynamic motion pictures;
a display quality improvement mechanism, deciding whether to trigger a display quality improvement based on the enable signal; and
a luminance control circuit, wherein when the display quality improvement is triggered, the luminance control circuit performs luminance compensation in response to the luminance control signal.

12. The display system of claim 11, wherein the display quality improvement mechanism is executed by an inverter with a controller for controlling output voltages to the backlight module.

13. The display system of claim 11, wherein the display quality improvement mechanism is executed by a black insertion circuit and the drive circuit further comprises an inverter with a controller for controlling output voltages to the backlight module.

14. The display system of claim 11, wherein the dynamic motion picture detector comprises:
a data latch, latching the input video data and outputting a latched video data;
a comparator, comparing the input video data and the latched video data to output a comparison result; and
a judgment unit, outputting the enable signal and the luminance control signal;
wherein when the comparison result indicates the input video data and the latched video data are not dynamic pictures, the enable signal is deactivated; otherwise, the enable signal is activated.

15. The display system of claim 12, wherein the controller receives feedback currents from the backlight module via a first resistor; and
the luminance control circuit includes:
an MOS transistor, the luminance control signal controlling ON/OFF state of the MOS transistor;
a second resistor, coupled between the first resistor and the MOS transistor; and
a third resistor, coupled between the second resistor and a ground terminal;
wherein when the MOS transistor is turned off, the controller performs luminance compensation by controlling and varying output voltages to the backlight module in response to voltage division by the first and second resistors.

16. The display system of claim 13, wherein the controller receives feedback currents from the backlight module via a first resistor; and
the luminance control circuit includes:
an MOS transistor, the luminance control signal controlling ON/OFF state of the MOS transistor;
a second resistor, coupled between the first resistor and the MOS transistor; and
a third resistor, coupled between the second resistor and a ground terminal;
wherein when the MOS transistor is turned off, the controller performs luminance compensation by controlling and varying output voltages to the backlight module in response to voltage division by the first and second resistors.
